(19) United States
(12) Patent Application Publication
(10) Pub. No.: US 2024/0281286 A1
(43) Pub. Date: Aug. 22, 2024

(54) RESOURCE BALANCING ACROSS EDGE COMPUTING SERVERS

(71) Applicant: International Business Machines Corporation, Armonk, NY (US)

(72) Inventors: Charan Acharya Chandrashekar, Bangalore (IN); Shwetha Gopalakrishna, Bangalore (IN); Sudhakar T. Seshagiri, Bangalore (IN); Prasanna Alur Mathada, Bangalore (IN)

(21) Appl. No.: 18/170,016

(22) Filed: Feb. 16, 2023

(51) Int. Cl. G06F 9/50

(52) U.S. Cl. CPC G06F 9/5027

(57) ABSTRACT

Balancing computational loading across UAV-MEC devices by receiving information associated with a data processing task, determining a first computational loading associated with the data processing task relative to a capacity of a first device, sending the first computational loading and a first location to a second device, determining that the second device can support the first computational loading, deploying, the second device to the first location, and completing the first computational task using the first device and the second device.

### FIELD OF THE INVENTION

The disclosure relates generally to the balancing of computational loading across multi-access edge-computing servers. The invention relates particularly to the balancing of computational loading across unmanned-aerial-vehicle (UAV) multi-access-edge-computing (MEC) devices.

### BACKGROUND

Internet of Things (IoT) devices generally have very limited or even no computation capability, because of which it is difficult for these devices to process, and store collected data.

Edge computing brings computational resources closer to the end use and has the potential to help IoT devices by processing the data collected by them. However, in some areas such as farms, deserts, mountain peaks, bodies of water etc. it may not be possible to install conventional edge servers. In such cases Unmanned Aerial Vehicles (UAV-MECs) integrated with the edge computing may be used. UAV-MECs fly closer to the IoT devices and process the data generated/collected by them. In some cases, results are passed back to IoT devices and in other cases results are passed to Centralized servers.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable balancing computational loading across devices.

Aspects of the invention disclose methods, systems and computer readable media associated with balancing computational loading across devices by receiving information associated with a data processing task, determining a first computational loading associated with the data processing task relative to a capacity of a first device, sending the first computational loading and a first location to a second device, determining that the second device can support the first computational loading, deploying, the second device to the first location, and completing the first computational task using the first device and the second device.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 provides a flowchart depicting an operational sequence according to an embodiment of the invention.

FIG. 4 depicts a network configuration according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Each individual UAV-MEC has its own processing capacity which depends upon a relevant edge server's configuration such as RAM, CPU, secondary memory etc. and it also depends on the UAV-MEC's battery capacity which determines how far the vehicle can travel and hover over the field at a designated location. The individual processing capacity may be insufficient to completely handle data gathering and computational tasks for field IoT devices. As an example, methods deploy multiple UAV-MECs to the field IoT devices. The data gathering and computational processing load generated by the IoT devices exceeds the processing capacity of a primary UAV-MEC. The primary UAV-MEC will process a portion of the data gathering and computational processing and return back to the base station to recharge. The primary UAV-MEC will have to make at least one additional trip to the field IoT devices to process another portion of the load. The IoT devices will generate additional data gathering and computational processing requirements during the absence of the UAV-MEC to recharge resulting in more trips to recharge and return. Such round-trips to recharge delay the processing of the IoT data and the provision of real-time results, or close to real-time results, thus impacting the quality of service.

Aspects of the present invention relate generally to balancing computational processing tasks across available resources and, more particularly, to balancing internet of things processing tasks across unmanned aerial vehicle multi-access edge computing server devices. Such devices combine mobile aerial vehicles with edge server processing power. This combination enables data processing to move directly to Internet of Things field locations for processing the data from such devices. In embodiments, systems and method dynamically determine a pending resource outage in performing processing tasks, identify the scope of the pending need, identify resources to meet the need, and enable the relocation of those resources to the field location where processing needs exist.

In accordance with aspects of the invention there is a method for automatically determining the scope of processing needs associated with field IoT devices, further determining that current resources at an IoT field site lack the necessary capacity to complete the full set of tasks, determine the scope of help needed, identify resources having the necessary capacity, and enabling the movement of those resources to the location where help is required. The additional resources then complete the processing tasks without the need for the original processing device to make multiple time-consuming trips to a base station to refuel.

Aspects of the invention provide an improvement in the technical field of Internet of Things data processing systems. By dynamically determining pending resource shortages and addressing such shortages using available resources, disclosed embodiments enable faster processing of the IoT data from field devices.

Aspects of the invention also provide an improvement to computer system functionality. In particular, implementations of the invention are directed to a specific improvement to the way IoT processing systems operate, embodied in the dynamically adjusted resources for completing network IoT tasks without delays due to capacity outages. In embodiments, the system dynamically identifies looming capacity outages and directs additional processing resources to locations where capacity will be required.

Disclosed embodiments enable a higher level of service quality by engaging additional UAV-MEC resources at the field location as needed to complete the current data gathering and processing tasks in a timely manner and without a need for round trips to recharge UAV-MECs. Disclosed embodiments provide systems and method for fleets of UAV-MECs to dynamically assess current tasks in terms of required UAV-MEC resources and to request help form peer devices for instances where the resource requirements of current tasks exceed the available resources of a primary UAV-MEC. In an embodiment, such requests for help may be made through a single hop to secondary UAV-MEC devices within the communications range of the primary UAV-MEC, or such requests may be made using a series of hops utilizing the communications range of a series of UAV-MECs. AS an example, a primary UAV-MEC seeks help from a one or more secondary peer UAV-MECs within its range. Unable to satisfy the unmet needs, each of the secondary devices then seeks help from tertiary devices, and so on, until satisfaction of the unmet needs occurs through the identification and utilization of sufficient devices. In an embodiment, a user provides input designating the number of communication iterations, or hops, to be evaluated after determining a need for help.

In an embodiment, methods link UAV-MEC devices in a communication network. In this embodiment, systems and method receive a maximum number of communication iterations, or hops, for forwarding requests for assistance from a primary UAV-MEC. Methods dispatch one or more devise to process data from IoT devices. In this embodiment, such UAV-MEC devices may incorporate data gathering and data processing capabilities associated with data processing servers. Upon arrival at a target location, a first UAV-MEC evaluates the computational task associated with the relevant IoT devices at the location.

In an embodiment, systems and methods gather data from edge IoT devices to enable an assessment of the current overall data gathering and computational tasks associated with the IoT devices. In this embodiment, systems and methods determine the computational capacity and energy required to complete the overall data gathering and computational loading tasks determined through the assessment.

In an embodiment, each UAV-MEC includes an evaluator module and a helper module. Such modules may include designated hardware and/or software components of the UAV-MEC processing systems. Once a UAV-MEC reaches a designated IoT field location, the evaluator module collects data from the relevant IoT devices and determines the current data gathering and computational processing requirements for the IoT devices at the location. The evaluator module considers parameters including the UAV-MEC's server's available RAM, CPU capabilities, available secondary memory, and UAV-MEC's current battery charge. In an embodiment, the formula (Help required) Hr=Le/Cu, where Le is the load generated by the edge IoT devices in terms of data size (MB, GB, TB, etc.); and Cu is the processing capacity of the UAV-MEC server in MB, GB, TB. Other formulas for determining the necessity of help for a may also be utilized. In an embodiment, where Hr exceeds 1, help is required and the systems and methods determine the extent of the required using the formula (load required) Lr=Le−Cu. In an embodiment, systems and methods pass the value of Lr to peer UAV-MECs thorough a single or multiple communications hops until sufficient peer devices to satisfy the load relocate to the field location and complete the tasks. In an embodiment, evaluator modules periodically determine the need for help by assessing remaining tasks and UAV-MEC resources.

In an embodiment, each UAV-MEC further includes a helper module for determining if the UAV-MEC has the current capacity to satisfy the Lr of a requesting peer UAV-MEC. In this embodiment, a secondary peer UAV-MEC receives a request for help including an indication of the specific value of Lr associated with the required help. The helper module of the secondary UAV-MEC then determines if it has sufficient current capacity to satisfy the Lr of the request using a formula such as (Support) S=Cu−(Les+Lr), or a similar formula, where Cu represents the capacity of the secondary UAV-MEC in bits, Les represents the load generated by IoT devices for the secondary UAV, and Lr represents the load required by the primary UAV-MEC according to the request. In this embodiment, methods and systems may further consider the current battery state of the secondary UAV-MEC in determining whether or not help can be provided in response to the request for the primary UAV-MEC. In this embodiment, the systems and methods utilize a formula such as: Bs=B−(Bc+Br+Bt)+Buffer, or similar formulas, where Bs—Battery support, B—total battery capacity of the secondary UAV-MEC, Bc—Battery required to process generated data,
Br—Battery required to process the requested data, Bt—Battery required to travel to requested UAV-MEC's location+time to travel to base, and Buffer—buffer energy for any unforeseen issues.

In an embodiment, the secondary UAV-MEC's helper module determines that the secondary UAV-MEC's server can provide requested support can be provided, as S is greater than zero, the secondary UAV-MEC then sends an acknowledgement message to the system and primary UAV-MEC. In this embodiment, the acknowledgement message includes the processing capacity available from the secondary UAV-MEC.

In an embodiment, the evaluator module of the primary UAV-MEC receives the acknowledgement message from a plurality of secondary or tertiary peer UAV-MECs. In this embodiment, the primary UAV-MEC evaluator module selects one of the secondary UAV-MECs for completing the current tasks. In this embodiment, the evaluator module makes this selection with consideration for the available capacities of each available UAV-MEC as well as the distance between each available UAV-MEC and the target IoT location as the selected UAV-MEC must then travel to the target location to complete the tasks and this travel takes time. In this embodiment, the primary UAV-MEC sends a response message to the selected UAV-MEC confirming the selection and instructing the selected UAV-MEC to proceed to the target IoT location and complete the tasks.

In an embodiment, the primary UAV-MEC evaluator module selects multiple secondary UAV-MECs according to the overall help needed and the available capacity of each available peer UAV-MEC. In this embodiment, the evaluator module of the primary UAV-MEC ranks potential secondary helper UAV-MECs according to the available capacity each has as well as the distance between each potential helper and the target location. The evaluator may then select multiple secondary helper UAV-MECs which have a combined capacity sufficiently large enough to complete the current tasks of the primary UAV-MEC. In this embodiment, the primary UAV-MEC continues the gathering and processing tasks as the secondary peer UAV-MEC proceeds to the location.

If the helper module determines the secondary UAV-MEC cannot support the requested help, then it will check the maximum number of hops to which requests needs to be forwarded according to default system values or user inputs. A secondary UAV-MEC at the last hop will do nothing further. A secondary UAV-MEC at an intermediate hop will forward the request for help to other UAV-MECs within its reach. The request will be forwarded until the number of hop iterations equals the maximum hop count.

For instances where the determined computational loading and energy requirements may be satisfied by a primary UAV-MEC at the location, that device completes the data gathering and computational processing and returns to its base station or to a second IoT servicing location designated by the systems and methods.

In an embodiment, where no secondary UAV-MECs have capacity to provide the requested help to the primary UAV-MEC after the maximum number of hops has been reached, the system and methods evaluate the tasks being executed by each potential secondary UAV-MEC and determine a ranking of respective priorities for the tasks of the primary UAV-MEC and those of the potential secondary UAV-MECs. In this embodiment, after the first round of hop iterations ahs failed to yield secondary UAV-MECs for completing the tasks of the primary UAV, the help request is resent to the available secondary peer UAV-MEC with a priority of the tasks of the primary UAV-MEC included in the request. Each task assigned to each UAV-MEC may have a priority assigned by a central authority. For example: Collection of data from area with security flag can have priority 1, capturing images from peaks can have priority 2, and collecting data from heat sensors can have priority 3.

Any potential secondary UAV-MEC executing a task having a lower task priority than that of the primary UAV-MEC's task follows the method set forth above to offload its current task to another UAV-MEC. This offloading of the task of the secondary UAV-MEC frees sufficient resources to enable the secondary UAV-MEC to travel to the IoT location and provide the help requested by the primary UAV-MEC.

In an embodiment, one or more components of the system can employ hardware and/or software to solve problems that are highly technical in nature (e.g., receiving information associated with a data processing task, determining a first computational loading associated with the data processing task, sending the first computational loading and a first location to a second device, determining that the second device can support the first computational loading, deploying, the second device to the first location, completing the first computational task using the first device and the second device, etc.). These solutions are not abstract and cannot be performed as a set of mental acts by a human due to the processing capabilities needed to facilitate computational load balancing across devices, for example. Further, some of the processes performed may be performed by a specialized computer for carrying out defined tasks related to load balancing. For example, a specialized computer can be employed to carry out tasks related to providing balanced remote edge processing capacity or the like.

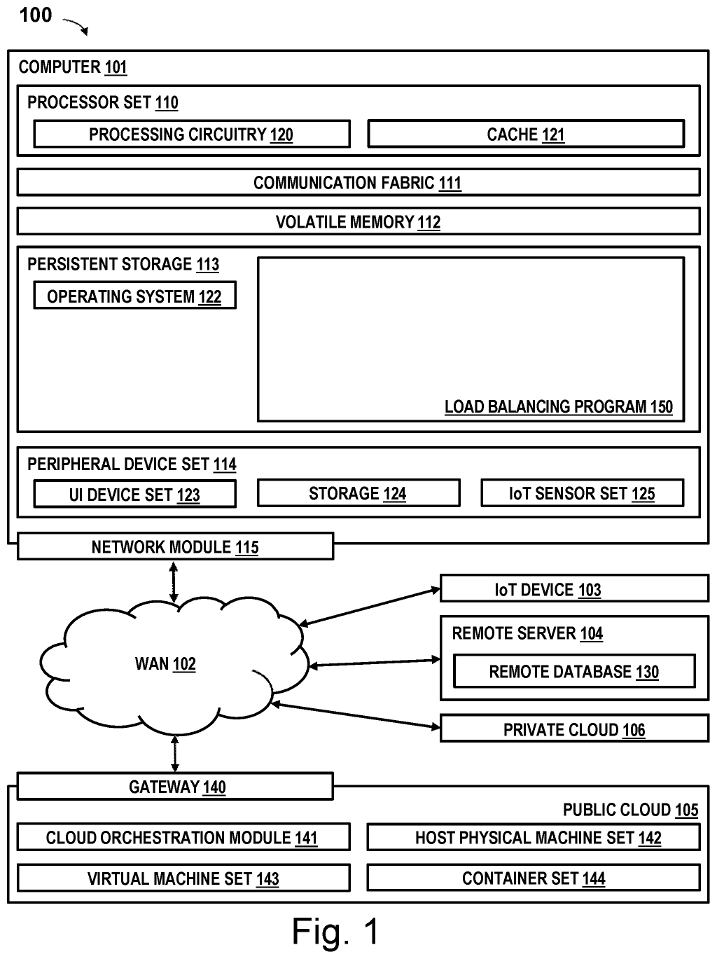

As shown in FIG. 1, computing environment 100 contains an example of an environment for the execution of at least some of the computer code involved in performing the inventive methods, such as dynamically identifying future processing capacity outages and redirecting resources to eliminate such capacity outages 150. In addition to block 150, computing environment 100 includes, for example, computer (including UAC-MEC devices) 101, wide area network (WAN) 102, internet of things (IoT) device 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

UAV-MEC COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated. Computer 101 may form a portion of a UAV-MEC device.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

IoT device 103 is any device that is used for gathering data for further processing. IoT device 103 may include sensor elements providing data on current conditions. IoT devices 103 may lack significant capacities for data storage or processing. Such a lack of capacity illustrates the need for UAV-MEC devices to collect and process the IoT device 103 data.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

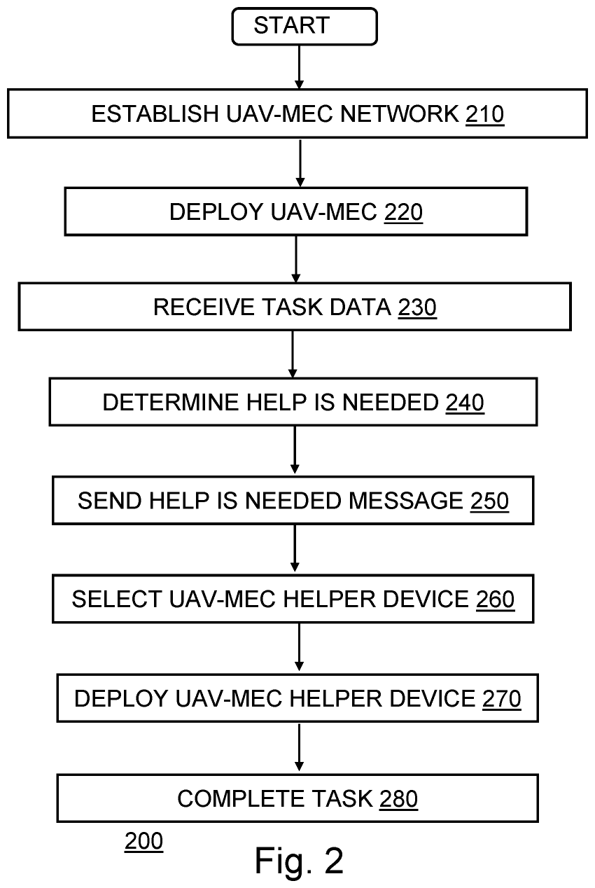

FIG. 2 provides a flowchart 200, illustrating exemplary activities associated with an embodiment of the disclosure. After program start, at block 210, systems and methods establish a communications network linking a plurality of UAV-MEC devices as peers. All devices form part a single hierarchy but may be divided into tiers according to the distance separating the UAV-MECs. For example, a primary UAV-MEC may be within communications range with a set of secondary UAV-MECs but unable to communicate with any UAV-MECs outside of its communications range. Further, each of the secondary UAV-MECs may be able to communicate with the primary UAV-MEC as well as additional UAV-MECs within the communications range of the secondary UAV-MEC. UAV-MECs may be linked using WIFIDIRECT, BLUETOOTH 5.0 or any other radio wave technology like wireless mesh network etc. (Note: the term(s) “WIFIDIRECT” and “BLUETOOTH 5.0” may be subject to trademark rights in various jurisdictions throughout the world and are used here only in reference to the products or services properly denominated by the marks to the extent that such trademark rights may exist.)

At block 220, systems and methods utilizing load balancing program 150, deploy at least one primary UAV-MEC to an IoT field location to gather and process data from IoT devices. The UAV-MEC may be deployed from a base station or from a current operations station.

At block 230, the primary UAV-MEC arrives at the location and queries the IoT devices regarding the data present and the required processing tasks. Systems and methods assess the received information and determine the resources necessary to gather the data and complete the processing tasks.

After determining the resources required to complete the necessary tasks, systems and methods evaluate the current resource state of the primary UAV-MEC to determine if the primary UAV-MEC has sufficient resources to complete the tasks. In an embodiment, methods determine that the primary UAV-MEC lacks sufficient resources to complete the tasks and that help is needed to complete the tasks.

At block 250, systems and methods send a help request message to all peer UAV-MECs within communications range of the primary UAV-MEC. This message includes the location of the IoT devices as well as the scale of the tasks necessary for completion. Each recipient secondary device processes the help request in view of its processing capacity and resource levels. Each secondary device having sufficient resources to provide the requested help responds to the primary UAV-MEC providing the location, and resource capacity of the secondary UAV-MEC.

At block 260 the primary device selects a helper device from among the set of secondary devices which have responded. This selection may be made according to the UAV-MEC location and indicated resource capacity. The primary UAV-MEC communicates an acknowledgement to the selected helper UAV-MEC.

At block 270, the selected helper deploys to the IoT location and follows a similar task pattern as described above. The helper UAV-MEC queries the IoT devices, determines the scope of the remaining task and begins performing the required tasks. The primary UAV-MEC need not wait for the arrival of the helper and instead may begin processing the tasks while sending the help request, receiving responses, selecting the helper and communicating with the selected helper. The primary and helper UAV-MECs complete the required tasks.

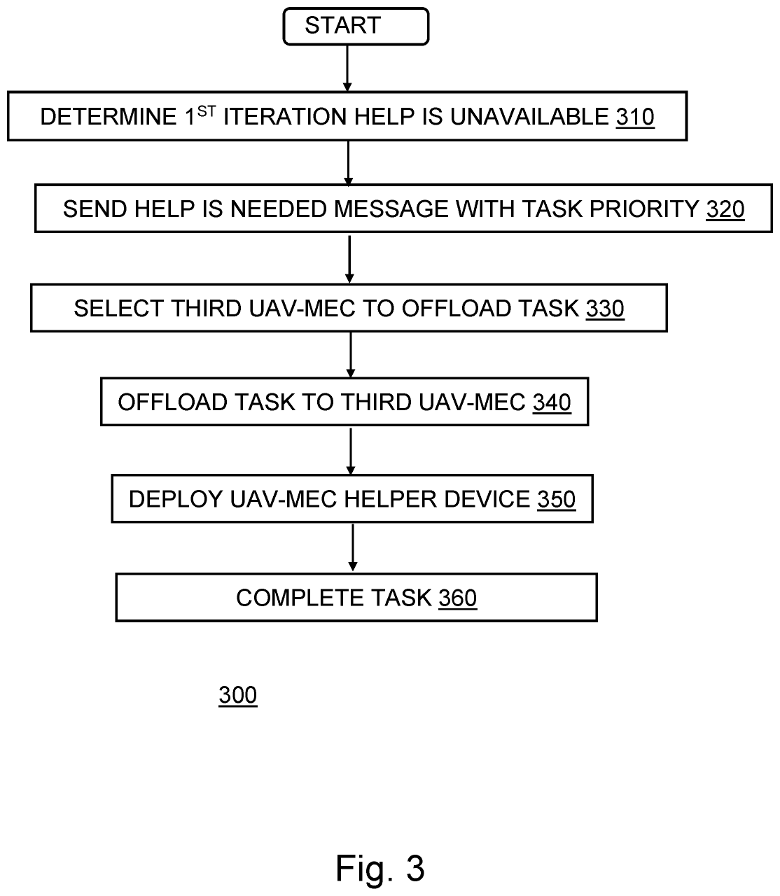

FIG. 3 provides a flowchart 300 depicting operational steps according to a second embodiment of the invention. At block 310, systems and methods complete a query of all available UAV-MEC devices accessible using the maximum number of hops designated by default or through user input. In an embodiment, the query results yield no UAV-MEC devices available to provide the help required.

At block 320, systems and methods resend the help required message to all secondary UAV-MECs within range of the primary UAV-MEC. In this embodiment, methods augment the help request message, adding a priority for the tasks of the primary UAV-MEC for which help is required.

At block 330, the secondary UAV-MECs evaluate the priority of the primary UAV-MECs task in comparison to the priority of their current tasks. Each secondary UAV-MEC which determines that the priority of the task of the primary UAV-MEC exceeds that of their current task determines the help required to offload their current task and sends a help required message to all peers within range. The peers proceed as described above to determine if resources are available to provide the help requested by the secondary UAV-MECs. UAV-MECs are able to provide help send acknowledgement messages to the secondary UAV-MEC. The secondary UAV-MEC selects a task offload helper from among any UAV-MECs providing an acknowledgement message, confirms the selection of the offload helper and offloads the current task to the offload helper at block 340.

At block 350 any secondary UAV-MECs which have successfully offloaded their task now respond to the primary UAV-MEC indicating that help can be provided, indicating their available capacity and location. The primary UAV-MEC selects and confirms a helper device which deploys to the location.

At block 360, the primary UAV-MEC and secondary UAV-MEC made available through task offloading to a third UAV, proceed to complete the necessary tasks at the location.

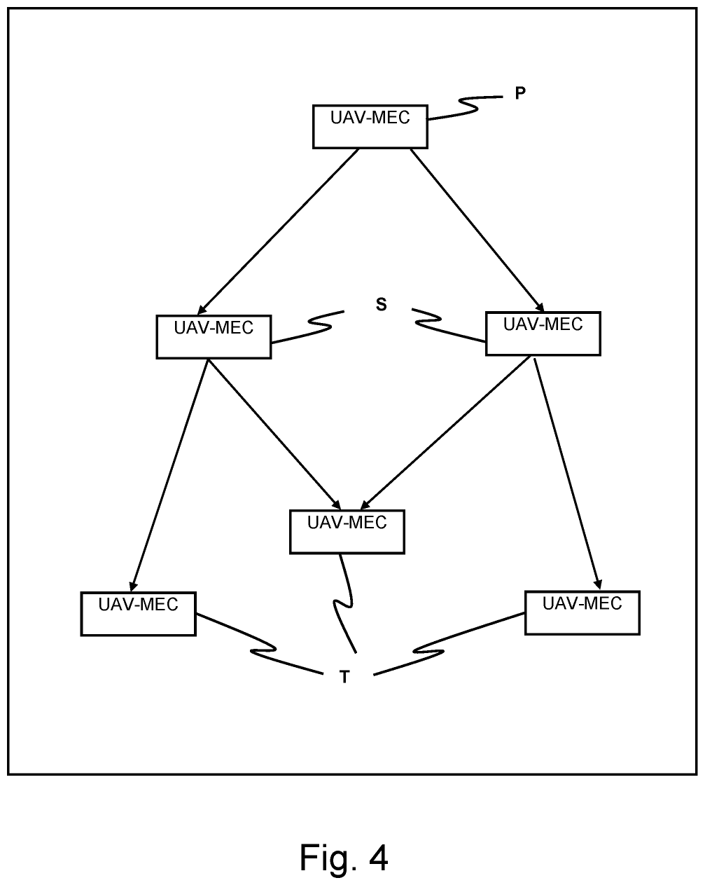

FIG. 4 depicts a network of UAV-MEC devices, arrayed such that device P represents a primary UAV-MEC at an IoT field location facing a capacity outage according to its evaluator module's assessment of the current tasks presented by the IoT devices. Devices S represent secondary UAV-MEC devices within the communications range of device P and devices T represent tertiary devices outside the communications range of device P but within the communications ranges of at least one device S. Failure to identify a device S having the capacity necessary to provide the help requested by device P, and having a maximum hops value of at least 2, leads to communication of the primary UAV-MEC's help request from devices S to devices T for capacity evaluation and action.

It is to be understood that although this disclosure includes a description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for balancing computational loading across UAV-MEC devices, the method comprising:
receiving, by one or more processors, information associated with a data processing task;
determining, by the one or more computer processors, a first computational loading associated with the data processing task relative to a capacity of a first device;
sending, by the one or more computer processors, the first computational loading and a first location to a second device;
determining, by the one or more computer processors, that the second device can support the first computational loading;
deploying, by the one or more computer processors, the second device to the first location; and
completing the first computational task using the first device and the second device.

2. The computer implemented method according to claim 1, further comprising:
creating, by the one or more processes, a communications network between the first device and the second device; and
deploying, by the one or more computer processors, the first device to the first location.

3. The computer implemented method according to claim 1, wherein determining that the second device can support the first computational loading according to a second device computational loading.

4. The computer implemented method according to claim 1, further comprising:
determining, by the one or more computer processors, that a plurality of second devices can support the first computational loading; and
selecting a second device from the plurality of second devices according a second device location and second device available resources.

5. The computer implemented method according to claim 1, further comprising deploying the first device to a base location.

6. The computer implemented method according to claim 1, further comprising executing, by the one or more computer processors, a number of communication iterations between the first device and the second device.

7. The computer implemented method according to claim 1, further comprising:
determining, by the one or more computer processors, that a third device can support the first computational loading;
deploying, by the one or more computer processors, the third device to the first location; and
completing the first computational task using the first device, the second device, and the third device.

8. A computer program product for balancing computational loading across devices, the computer program product comprising one or more computer readable storage media and collectively stored program instructions on the one or more computer readable storage media, which, when executed cause one or more processors to:
receive information associated with a data processing task;
determine a first computational loading associated with the data processing task relative to a capacity of a first device;
send the first computational loading and a first location to a second device;
determine that the second device can support the first computational loading;
deploy the second device to the first location; and
complete the first computational task using the first device and the second device.

9. The computer program product according to claim 8, the stored instruction further causing the one or more processors to:
create a communications network between the first device and the second device; and
deploy the first device to the first location.

10. The computer program product according to claim 8, wherein determining that the second device can support the first computational loading according to a second device computational loading.

11. The computer program product according to claim 8, the stored instruction further causing the one or more processors to:
determine that a plurality of second devices can support the first computational loading; and
select a second device from the plurality of second devices according a second device location and second device available resources.

12. The computer program product according to claim 8, the stored instruction further causing the one or more processors to deploy the first device to a base location.

13. The computer program product according to claim 8, the stored instruction further causing the one or more processors to execute a number of communication iterations between the first device and the second device.

14. The computer program product according to claim 8, the stored instruction further causing the one or more processors to:
determine that a third device can support the first computational loading;
deploy the third device to the first location; and
complete the first computational task using the first device, the second device, and the third device.

15. A computer system for balancing computational loading across devices, the computer system comprising:
one or more computer processors;
one or more computer readable storage devices; and
stored program instructions on the one or more computer readable storage devices for execution by the one or more computer processors, which, when executed cause the one or more processors to:
receive information associated with a data processing task;
determine a first computational loading associated with the data processing task relative to a capacity of a first device;
send the first computational loading and a first location to a second device;
determine that the second device can support the first computational loading;
deploy the second device to the first location; and
complete the first computational task using the first device and the second device.

16. The computer system according to claim 15, the stored instruction further causing the one or more processors to:
create a communications network between the first device and the second device; and
deploy the first device to the first location.

17. The computer system according to claim 15, wherein determining that the second device can support the first computational loading according to a second device computational loading.

18. The computer system according to claim 15, the stored instruction further causing the one or more processors to:
determine that a plurality of second devices can support the first computational loading; and
select a second device from the plurality of second devices according a second device location and second device available resources.

19. The computer system according to claim 15, the stored instruction further causing the one or more processors to deploy the first device to a base location.

20. The computer system according to claim 15, the stored instruction further causing the one or more processors to execute a number of communication iterations between the first device and the second device.
